(19) United States
(12) Patent Application Publication
(10) Pub. No.: US 2012/0138718 A1
(43) Pub. Date: Jun. 7, 2012

(54) VERTICAL ROLLER MILL

(76) Inventors: Takuichiro Daimaru, Minato-ku (JP); Yasuhiro Sueoka, Minato-ku (JP); Kenichi Arima, Minato-ku (JP); Tsugio Yamamoto, Minato-ku (JP); Takashi Tsutsuba, Minato-ku (JP); Shinji Matsumoto, Minato-ku (JP); Koki Matsuzaki, Minato-ku (JP); Sotaro Yamaguchi, Minato-ku (JP)

(21) Appl. No.: 13/389,492

(22) PCT Filed: Nov. 18, 2010
(86) PCT No.: PCT/JP2010/070610

§ 371 Date: Feb. 8, 2012

(30) Foreign Application Priority Data
Nov. 20, 2009 (JP) 2009-265176

(51) Int. Cl. B02C 23/12; B02C 15/00

(52) U.S. Cl. 241/79

(57) ABSTRACT

In a vertical roller mill including a fixed classifier, a proportion of coarse particles in a pulverized coal product is reduced. The vertical roller mill (10) includes a cyclone-type fixed classifier (20A) provided within a casing (11) for classifying fine powder having a small particle diameter by centrifugal force and discharging the classified powder to the outside. The fixed classifier (20A) is adapted to discharge the fine powder to the outside from a pulverized coal outlet (16) at an upper side through a lower end portion of an inner cylinder (24) provided inside a cone (21) by introducing a solid-gas two-phase flow into the inside from a fixed vane inlet window (22) opened on the cone (21) and swirling the solid-gas two-phase flow using a fixed vane (23) arranged in the vicinity of the inner side of the fixed vane inlet window (22). A deflector (26) is provided in the vicinity of the fixed vane inlet window (22) for strengthening the solid-gas two-phase flow delivered into the inside of the cone (21) from the fixed vane inlet window (22) in the downward direction.

### TECHNICAL FIELD

The present invention relates to a vertical roller mill applied to a pulverized coal-fired boiler or the like.

### BACKGROUND ART

Conventionally, in a coal-fired boiler, raw coal is injected into a mill such as a vertical roller mill 10 as shown in FIG. 11 and pulverized coal is used as fuel. In the vertical roller mill 10, a grinding roller 13 is rotated and swirled on a grinding table 12 arranged in a lower portion of a casing 11. The reference numeral 14 in the drawings denotes a coal injection tube into which raw coal is injected.

The raw coal injected into the vertical roller mill 10 is bitten between the grinding table 12 and the grinding roller and pulverized. The pulverized coal is dried by hot air ejected from a throat 15 arranged around the grinding table 12 and is conveyed by airflow to a fixed classifier 20 arranged in an upper portion of the casing 11. At this time, coarse particles having a large particle diameter are subjected to gravity classification so as to be dropped by gravity and returned to the grinding table 12. The coarse particles are pulverized repeatedly until they have a desired particle diameter.

After the particles are primarily classified by the gravity classification, product pulverized coal containing coarse particles is further classified by a classifier arranged above the grinding table 12. Such a classifier may be a fixed classifier, a rotary classifier, or a fixed and rotary classifier. The classifier shown in FIG. 11 is the fixed classifier. Incidentally, the rotary classifier classifies particles by crash into rotary vanes and inertial force, and has a high classification performance.

The pulverized coal conveyed by airflow is dried by hot air and classified by passing through the fixed classifier 20. The classified pulverized coal is delivered through a pulverized coal outlet 16 connecting the inside of the fixed classifier 20 to the upper outside of the casing 11 and is conveyed by primary air to the boiler.

As shown in FIGS. 12 and 13, the fixed classifier 20 includes a plurality of fixed vane inlet windows 22 opened at equal intervals in the circumferential direction on an upper end portion of a cone 21. The fixed vane inlet windows 22 are opened portions penetrating a wall surface forming the cone 21, and serve as inlets and flow paths through which the pulverized coal is delivered by airflow (referred to as “solid-gas two-phase flow”) to be flowed into the inside of the cone 21. A fixed vane 23 is attached to the inner wall of the cone 21 to be pair with each fixed vane inlet window 22.

Further, an inner cylinder 24 is provided inside of the cone 21 to form a wall surface opposite to the fixed vane inlet windows 22 and the fixed vanes 23. All fixed vanes 23 are inclined in the same direction to swirl the solid-gas two-phase flow. In other words, the fixed vanes 23 are provided to have an inclined angle θ from the line extending to the axial center of the cone 21 in the radial direction (see FIG. 13). By increasing or decreasing the inclined angle θ of each fixed vane 23, the strength of the swirling flow is changed depending on the opening degree (angle) of the fixed vane 23. Thus, the fineness of classified particles can be adjusted.

The reference numeral 25 in the drawings denotes a cone outlet for supplying raw coal and coarse particles classified by the classifier 20 to the grinding table 12.

The above-described fixed classifier 20 is a cyclone-type classifier with a simple structure in which a drive part is not provided. Therefore, it can be easily maintained at low cost. However, the classification of coarse particles by the fixed classifier 20 is not accurate and therefore the coarse particles (coarse particles larger than 100 mesh which negatively affects combustibility) in the pulverized coal are increased. Thus, unburned content contained in combustion exhaust gas discharged from the boiler is increased.

Here, the classification principle of the fixed classifier 20 will be briefly explained. In the solid-gas two-phase flow passing between the adjacent fixed vanes 23 from the fixed vane inlet windows 22, particles in pulverized coal are centrifugally classified into coarse particles and fine powder by the swirl flow. Subsequently, the light fine powder having a small particle diameter is entrained in the reverse upward flow from the lower side and delivered into the inside from the lower side of the inner cylinder 24 to be discharged to the outside of the vertical roller mill 10 from the pulverized coal outlet 16. However, the centrifugally classified coarse particles having a large particle diameter is heavy and thus is not entrained in the airflow flowing into the inside of the inner cylinder 24 from the lower side of the inner cylinder 24. Thus, the coarse particles are delivered to the inner wall of the cone 21 and dropped downward by gravity along the inner wall surface of the cone 21. The coarse particles are eventually dropped to the grinding table 12 through the coal injection tube 14 opened toward the lower center of the cone 21 and then pulverized again.

In view of such circumstances, the rotary classifier having a high classification performance is used when fire-retardant coal is mainly used as raw coal and the highly fineness (approximately 80% passing 200 mesh) is required. However, when relatively combustible coal is used as raw coal, the fineness of product particles can be relatively low (approximately 70% passing 200 mesh). Thus, the fixed classifier 20 which has a simple structure at low cost can be employed.

According to a conventional technique relating to a vertical roller mill equipped with the above-described fixed classifier, it is suggested that a wave-shaped blade is provided by modifying a plane plate-shaped fixed vane in order to improve a pulverized coal classification performance. When a mixed airflow swirling upward with primary air is entered between wave-shaped blades of a fixed classifier, coarse particles crash into airflow crashing parts of the wave-shaped blades to be classified even when the coarse particles are delivered at any incident angle. Thus, the classification performance of the fixed classifier is improved (for example, see Patent Literature 1).

### CITATION LIST

### Patent Literature

{PTL 1} Japanese Unexamined Patent Application, Publication No. Hei 10-230181

### SUMMARY OF INVENTION

### Technical Problem

As described above, in the fixed classifier 20 of the vertical roller mill 10, the fixed vanes 23 swirl the solid-gas two-phase flow after pulverization and gravity classification to classify particles into coarse particles and fine powder by centrifugal force. However, coarse powder having a diameter close to a product particle diameter (approximately 150 μm of a particle diameter between the size of coarse particles and the size of the fine powder, which becomes unburned content) is not easily affected by centrifugal force. Thus, part of the coarse powder is delivered in the vicinity of the inner cylinder 24 in the central direction by fluctuation of airflow, and is swirled and moved downward in the vicinity of the inner cylinder 24. Consequently, the probability that the coarse powder is caught up in the reverse upward flow of the fine powder is increased. The classification efficiency is reduced by increase of the amount of the coarse powder caught up in the product fine powder.

On the other hand, in the above-described fixed classifier 20, the fineness is adjusted and set by adjusting the opening degree of the fixed vane 23. More specifically, the fineness is increased by throttling the opening degree of the fixed vane 23 (increasing the inclined angle θ) and increasing the centrifugal force. To the contrary, the fineness is decreased by increasing the opening degree of the fixed vane 23 (reducing the inclined angle θ) and reducing the centrifugal force. When the fineness is reduced by increasing the opening degree of the fixed vane 23, the coarse powder passing through the fixed vane 23 is not sufficiently classified by centrifugal force. Thus, the coarse powder is delivered in the central direction with the fine powder and easily entrained in the reverse upward flow, thereby promoting the reduction of the classification accuracy.

Further, part of the coarse particles delivered in the central direction crash into the inner cylinder 24 depending on the opening degree of the fixed vane 23, and is rebounded to be floated between the fixed vane 23 and the inner cylinder 24 or dropped down along the side surface of the inner cylinder 24. Therefore, the classification accuracy is reduced.

When the opening degree of the fixed vane 23 is throttled, part of the coarse particles are slipped from the airflow to crash into the fixed vane 23 and are rebounded, thereby describing an irregular track. Such behavior of the coarse particles is not favorable because the proportion of the coarse particles caught up in the produce fine powder is increased and thus the classification accuracy is further reduced.

When the above-described coarse particles are delivered upward from the lower portion of the vertical roller mill 10 into the fixed classifier 20, the coarse particles are drifted in the upper portion of the vertical roller mill 10 by inertial force and then delivered to the fixed vanes 23. Since the coarse particles tend to be drifted and delivered into the upper side of the fixed vanes 23, a region where a particle concentration (density) is high is formed on the upper portion of the vertical roller mill 10 (the upper portion of the fixed vanes 23) and the particles are collided, interfered, and grouped in this region. Thus, the classification efficiency is further reduced.

Recent years, the need for low-grade coal at low cost has been increased because of worldwide depletion of energy resources. A fixed classifier has been expected to be applied as a classifier for relatively combustible low-grade coals.

Also, a coal-fired boiler has been required to be operated with high efficiency (reduction of unburned content in coal) and low NOx fuel. Thus, a fixed classifier capable of reducing a proportion of coarse particles in powdered coal product has been desired.

The present invention has been made in the above-described circumstances. It is an object of the present invention to provide a vertical roller mill including a fixed classifier, which reduces a proportion of coarse particles (a proportion of coarse particles larger than 100 mesh which negatively affects combustibility) in powdered coal product.

### Solution to Problem

The aforementioned object is achieved by the following solutions.

A vertical roller mill according to a first aspect of the present invention includes: a cyclone-type fixed classifier provided within a casing for classifying fine powder having a small particle diameter by centrifugal force in a solid-gas two-phase flow conveying powder provided by crushing a solid and for discharging the fine powder to an outside, the fixed classifier being adapted to discharge the fine powder to the outside from a fine powder outlet at an upper side through a lower end portion of an inner cylinder provided inside a conical member by introducing the solid-gas two-phase flow into an inside of the conical member from a fixed vane inlet window opened on the conical member and swirling the solid-gas two-phase flow using a fixed vane mounted near an inner side of the fixed vane inlet window; and a deflecting member provided near the fixed vane inlet window for strengthening the solid-gas two-phase flow delivered into the inside of the conical member from the fixed vane inlet window in a downward direction.

Since the deflecting member for strengthening the solid-gas two-phase flow delivered into the inside of the conical member from the fixed vane inlet window in the downward direction is provided in the vicinity of the fixed vane inlet window in the vertical roller mill according to the first aspect of the present invention, a downward velocity component in the solid-gas two-phase flow passing by the fixed vane is increased. Accordingly, heavy coarse powder having a larger particle diameter in the solid-gas two-phase flow is delivered downward. Thus, an amount of coarse powder delivered substantially horizontally toward an axial center of the fixed classifier and entrained in a reverse upward flow is reduced.

In the vertical roller mill according to the first aspect of the present invention, it is preferable that the deflecting member is a deflector extending obliquely downward and attached on at least one of an outer side and the inner side of the fixed vane inlet window. Thus, in the solid-gas two-phase flow passing by the deflector, a downward velocity component guided by the obliquely downward deflector to be delivered into the inside of the conical member is increased. The shape of the deflector is not limited to a particular shape such as a flat plane and curved plane. Also, the number of deflectors may be appropriately changed depending on the condition.

In the vertical roller mill according to the first aspect of the present invention, it is preferable that the deflecting member is one or a plurality of deflecting blades extending obliquely downward and attached to the fixed vane. Thus, in the solid-gas two-phase flow passing by the deflector, a downward velocity component guided by the obliquely downward deflecting blades to be delivered into the inside of the conical member is increased. The shape of the deflecting blade is not limited to a particular shape such as a flat plane and curved plane. Also, the number of deflecting plates (blade rows) may be appropriately changed depending on the condition.

In the vertical roller mill according to the first aspect of the present invention, it is preferable that the deflecting member is an inclined surface formed on an uppermost portion of the casing and guiding the flow to the fixed vane inlet window. Thus, in the solid-gas two-phase flow passing by the inclined surface, a downward velocity component guided by the obliquely downward surface to be delivered into the inside of the conical member is increased. The inclined surface is not limited to a particular shape such as a flat plane and curved plane.

A vertical roller mill according to a second aspect of the present invention includes a cyclone-type fixed classifier provided within a casing for classifying fine powder having a small particle diameter by centrifugal force in a solid-gas two-phase flow conveying powder provided by crushing a solid and for discharging the fine powder to an outside, the fixed classifier being adapted to discharge the fine powder to the outside from a fine powder outlet at an upper side through a lower end portion of an inner cylinder provided inside a conical member by introducing the solid-gas two-phase flow into an inside of the conical member from a fixed vane inlet window opened on the conical member and swirling the solid-gas two-phase flow using a fixed vane mounted near an inner side of the fixed vane inlet window, in which an opening degree of the fixed vane is increased continuously or gradually in a downward direction.

Since the opening degree of the fixed vane is increased continuously or gradually in a downward direction in the vertical roller mill according to the second aspect of the present invention, a velocity component along the inner wall of the conical member in the flow at the upper side where the opening degree is throttled is increased. Thus, an amount of coarse powder delivered substantially horizontally toward an axial center of the fixed classifier and entrained in a reverse upward flow is reduced. In other words, the solid-gas two-phase flow delivered from the fixed vane inlet window changes its direction to the substantially horizontal direction from an upward flow and thus coarse particles having a large particle diameter in powder swept up into the solid-gas two-phase flow tend to flow at the upper side by inertial force (a particle concentration at the upper side is increased). Thus, when the velocity component along the inner wall of the conical member in the flow at the upper side is increased, the probability that the coarse particles are entrained in the reverse upward flow is reduced.

At this time, when the fixed vane is divided into a plurality of vanes in the vertical direction and their opening degrees are set to be increased from the upper vane toward the lower vane in a stepwise manner, the structure in which the opening degree of the fixed vane is increased downward in a stepwise manner can be easily provided.

A vertical roller mill according to a third aspect of the present invention includes a cyclone-type fixed classifier provided within a casing for classifying fine powder having a small particle diameter by centrifugal force in a solid-gas two-phase flow conveying powder provided by crushing a solid and for discharging the fine powder to an outside, the fixed classifier being adapted to discharge the fine powder to the outside from a fine powder outlet at an upper side through a lower end portion of an inner cylinder provided inside a conical member by introducing the solid-gas two-phase flow into an inside of the conical member from a fixed vane inlet window opened on the conical member and swirling the solid-gas two-phase flow using a fixed vane mounted near an inner side of the fixed vane inlet window, in which the lower end portion of the inner cylinder has a shape which expands a space formed between the lower end portion and the fixed vane.

Since the lower end portion of the inner cylinder has the shape which expands the space formed between the lower end portion and the fixed vane in the vertical roller mill according to the third aspect of the present invention, the distance where coarse powder passing by the fixed vane and flowing toward the center reach the inner cylinder is increased. Consequently, the probability that heavy coarse particles having a large particle diameter are entrained in the reverse upward flow heading to the upper inside of the inner cylinder from the inlet of the inner cylinder is reduced.

A preferred shape of the inner cylinder is provided by a conical trapezoidal shape narrowing toward the lower end portion or combining the conical trapezoidal shape narrowing toward the lower end portion and a cylindrical shape. When the conical trapezoidal shape and the cylindrical shape are combined, the position of the cylinder may be positioned at the upper side or lower side as long as the diameter is decreased toward the lower end portion of the inner cylinder.

A vertical roller mill according to a fourth aspect of the present invention includes: a cyclone-type fixed classifier provided within a casing for classifying fine powder having a small particle diameter by centrifugal force in a solid-gas two-phase flow conveying powder provided by crushing a solid and for discharging the fine powder to an outside, the fixed classifier being adapted to discharge the fine powder to the outside from a fine powder outlet at an upper side through a lower end portion of an inner cylinder provided inside a conical member by introducing the solid-gas two-phase flow into an inside of the conical member from a fixed vane inlet window opened on the conical member and swirling the solid-gas two-phase flow using a fixed vane mounted near an inner side of the fixed vane inlet window; and a rectifying mechanism provided at an inlet of the fixed vane inlet window for dividing the solid-gas two-phase flow in a vertical direction.

Since the rectifying mechanism for dividing the solid-gas two-phase flow in a vertical direction is provided at the inlet of the fixed vane inlet window in the vertical roller mill according to the fourth aspect of the present invention, deviation of a particle concentration distribution in the solid-gas two-phase flow in the vertical direction is corrected and the solid-gas two-phase flow is delivered to the fixed vane with the substantially constant particle concentration distribution.

In other words, the solid-gas two-phase flow delivered from the fixed vane inlet window changes its direction to the substantially horizontal direction from the upward flow and thus coarse particles having a large particle diameter in powder swept up into the solid-gas two-phase flow tend to flow at the upper side by inertial force to form the particle concentration distribution. In the region where the particle concentration is high, particles are crashed, interfered, and grouped, which causes the reduction of the classification accuracy. Thus, the classification accuracy is effectively improved by correcting the particle concentration distribution.

The shape of the rectifying mechanism is not limited to a particular shape such as a curved plane such as a substantially quadrant and combined straight lines. Also, the number thereof can be appropriately changed depending on the condition.

### Advantageous Effects of Invention

In the vertical roller mill including the fixed classifier according to the present invention, a proportion of coarse particles (a proportion of coarse particles larger than 100 mesh which negatively affects combustibility) in powdered coal product can be reduced. Therefore, by applying the vertical roller mill according to the present invention to a pulverized coal-fired boiler, a proportion of coarse particles in a pulverized coal product can be reduced and thus an unburned content in the coal can be reduced.

Thus, the fixed classifier, which can be easily maintained at low cost because of a simple structure without a drive part, can be adopted as a classifier for relatively combustible low-grade coal to provide a coal (pulverized coal) fired boiler which burns low-cost and low-grade coal as pulverized coal fuel.

### BRIEF DESCRIPTION OF DRAWINGS

FIG. 1 show a vertical roller mill according to a first embodiment of the present invention. FIG. 1(a) is a longitudinal cross-sectional view of a structure in the vicinity of a fixed classifier, and FIG. 1(b) is a cross-sectional view taken along the line A-A of FIG. 1(a).

FIG. 2 show a vertical roller mill according to a first modification of the present invention. FIG. 2(a) is a longitudinal cross-sectional view of a structure in the vicinity of a fixed classifier, and FIG. 2(b) is a cross-sectional view taken along the line B-B of FIG. 2(a).

FIG. 3 show a vertical roller mill according to a second modification of the present invention. FIG. 3(a) is a longitudinal cross-sectional view of a structure in the vicinity of a fixed classifier, and FIG. 3(b) is a perspective view exemplifying a structure of deflecting blade rows provided on a fixed vane shown in FIG. 3(a).

FIG. 4 shows a vertical roller mill according to a third modification of the present invention, and is a longitudinal cross-sectional view of a structure in the vicinity of a fixed classifier.

FIG. 5 show a vertical roller mill according to a second embodiment of the present invention. FIG. 5(a) is a longitudinal cross-sectional view of a structure in the vicinity of a fixed classifier, and FIG. 5(b) is a cross-sectional view taken along the line C-C of FIG. 5(a).

FIG. 6 shows a vertical roller mill according to a third embodiment of the present invention, and is a longitudinal cross-sectional view of a structure in the vicinity of a fixed classifier.

FIG. 7 shows a vertical roller mill according to a first modification of the third embodiment as shown in FIG. 6, and is a longitudinal cross-sectional view of a structure in the vicinity of a fixed classifier.

FIG. 8 shows a vertical roller mill according to a second modification of the third embodiment as shown in FIG. 6, and is a longitudinal cross-sectional view of a structure in the vicinity of a fixed classifier.

FIG. 9 shows a vertical roller mill according to a fourth embodiment of the present invention, and is a longitudinal cross-sectional view of a structure in the vicinity of a fixed classifier.

FIG. 10 are illustrations for explaining effects brought by a rectifying mechanism shown in FIG. 9 according to a relationship between a particle concentration distribution (horizontal axis) at an opening portion of a fixed vane inlet and a fixed vane inlet vertical direction (vertical axis).

FIG. 10(a) is the illustration for explaining the effect before the rectifying mechanism is provided, and FIG. 10(b) is the illustration for explaining the effect after the rectifying mechanism is provided.

FIG. 11 is a longitudinal cross-sectional view exemplifying a schematic structure of a vertical roller mill.

FIG. 12 is a longitudinal cross-sectional view exemplifying a conventional structure of a fixed classifier.

FIG. 13 is a cross-sectional view taken along the line D-D of FIG. 12.

### DESCRIPTION OF EMBODIMENTS

A vertical roller mill according to embodiments of the present invention will be explained below with reference to the accompanying drawings.

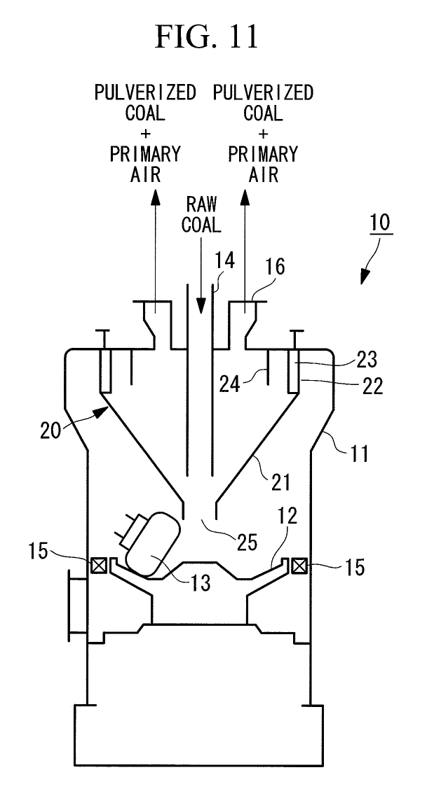

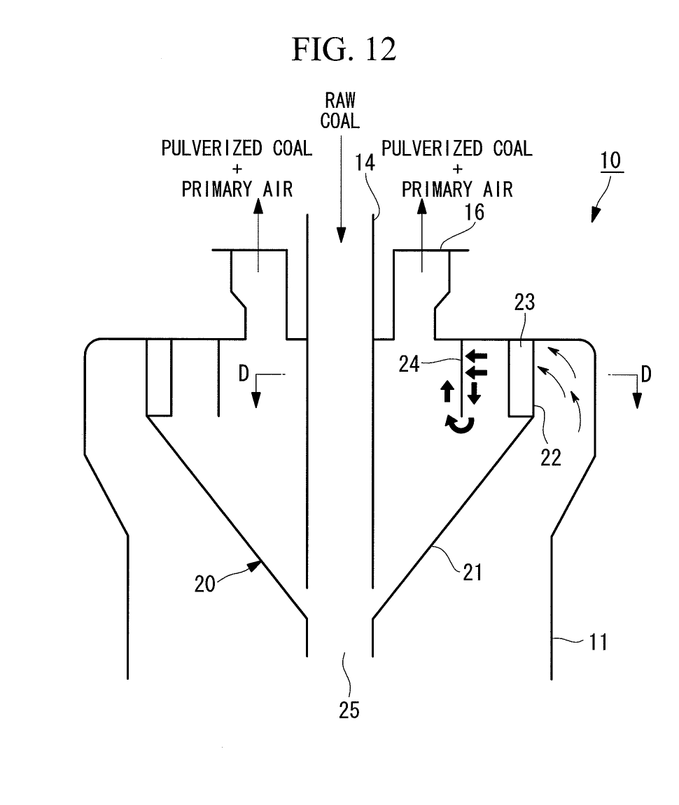

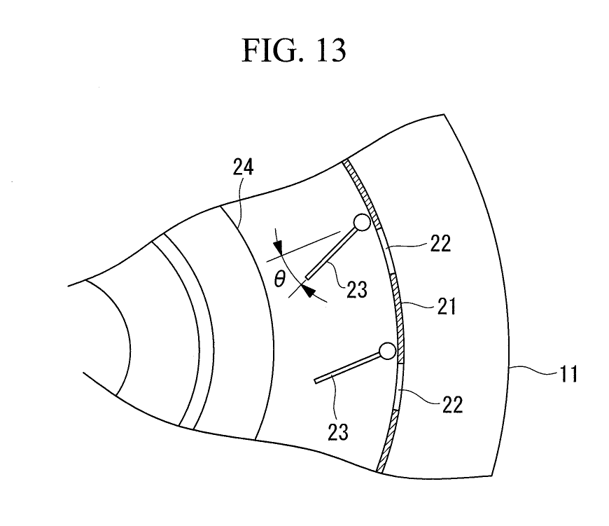

A vertical roller mill 10 shown in FIG. 11 is an apparatus (coal mill) for producing pulverized coal serving as fuel for a pulverized coal-fired boiler. The vertical roller mill 10 crushes raw coal to provide pulverized coal. The pulverized coal is classified by gravity and then is classified by a fixed classifier 20. The fine powder product provided by classification at the fixed classifier 20 is delivered by primary air as pulverized coal fuel having a desired fineness from a pulverized coal outlet (fine powder outlet) 16 provided on the upper portion of the vertical roller mill 10 toward a pulverized coal-fired boiler.

The structure of the vertical roller mill 10 according to the embodiment is the same as the above-described structure of the conventional vertical roller mill except for the structure of the fixed classifier 20 as described later. Thus, the explanation thereof is omitted.

The vertical roller mill 10 according to the present invention includes a cyclone-type fixed classifier 20 in the upper portion of the casing 11. The fixed classifier 20 classifies fine powder having a small particle diameter by centrifugal force and allows the classified powder to flow out to the pulverized coal-fired boiler (outside) due to a solid-gas two-phase flow (pulverized coal+primary air) conveying pulverized coal (powder) provided by crushing raw coal (solid). The fixed classifier 20 is adapted to discharge light fine powder having a small particle diameter to the outside of the cone from the pulverized coal outlet 16 at the upper side through the lower end portion of an inner cylinder 24 provided inside the cone 21 by introducing the solid-gas two-phase flow into the inside of the cone from fixed vane inlet windows 22 opened on the cone (conical member) 21 and swirling the solid-gas two-phase flow using fixed vanes 23 arranged in the vicinity of the inner sides of the fixed vane inlet windows 22.

In other words, the fine powder having a smaller diameter than a desired particle diameter is delivered through the lower end portion of the inner cylinder 24 arranged in the fixed classifier 20 and is entrained in the reverse upward flow to be classified. Then, the fine powder is discharged through the pulverized coal outlet 16 opened toward the upper side. Accordingly, the fine powder is supplied from the fixed classifier 20 and the vertical roller mill 10 to a pulverized coal-fired boiler as fine powder product (pulverized coal for fuel).

### First Embodiment

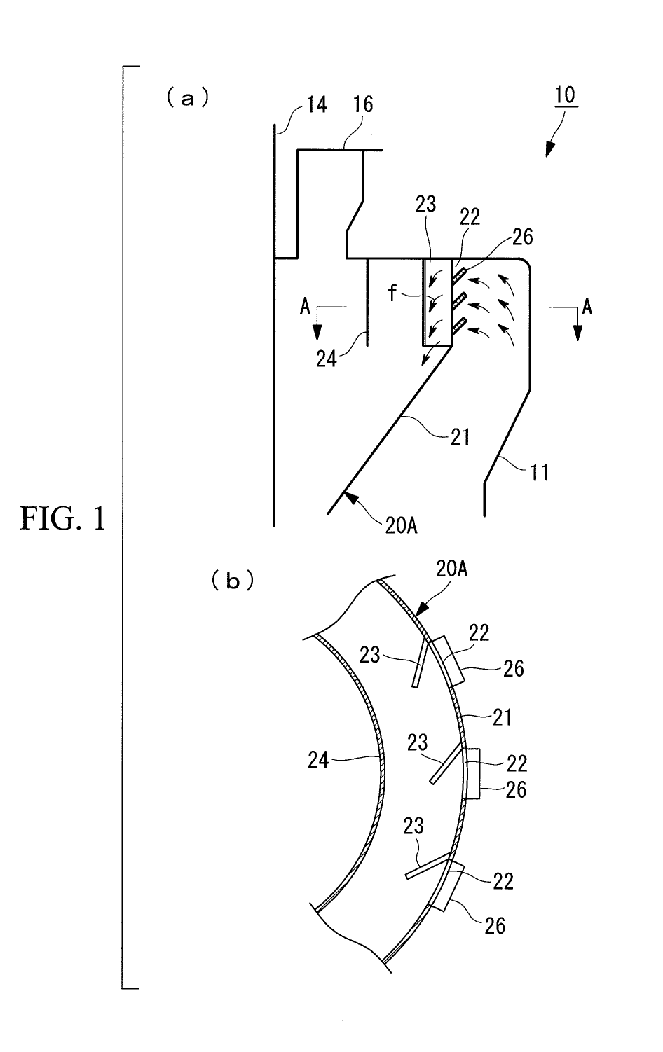

In a first embodiment, a fixed classifier 20A as shown in FIG. 1 is adopted instead of the above-described fixed classifier 20. Deflectors 26 extending obliquely downward and mounted to the outer sides of the fixed vane inlet windows 22 are provided as deflecting members provided in the vicinity of the fixed vane inlet windows 22 for strengthening the solid-gas two-phase flow flowing into the inside of the cone 21 from the fixed vane inlet windows 22 in the downward direction.

The fixed classifier 20A includes the cone 21 and the inner cylinder 24 concentric with the cone 21 and arranged inside the cone 21 to be spaced away from the cone 21 at a predetermined interval and is formed in a double cylindrical shape. The pulverized coal outlet 16 for discharging the classified product fine powder is provided at the inner side (axial center side) of the inner cylinder 24 to be opened toward the upper side. Also, a cone outlet 25 for dropping the collected coarse particles and returning them to the grinding table 12 is opened at the lower portion of the cone 21.

A number of fixed vane inlet windows 22 opened at equal intervals in the circumferential direction are provided on the upper end portion of the cone 21. The fixed vane inlet windows 22 are opened portions penetrating the wall surface forming the cone 21, and serve as inlets and flow paths for delivering the pulverized coal entrained in the solid-gas two-phase flow by primary air into the inside of the cone 21. At this time, the solid-gas two-phase flow delivered into the fixed vane inlet windows 22 changes its direction by approximately 90 degrees from the upward flow conveying the pulverized coal crushed on the grinding table 12 arranged in the lower portion of the casing 11.

Further, the fixed vanes 23 are attached to the inner wall of the cone 21 to be pair with the fixed vane inlet windows 22.

The fixed vanes 23 have the same inclined angle θ in the same direction to swirl the solid-gas two-phase flow. Accordingly, the solid-gas two-phase flow delivered from the fixed vane inlet windows 22 is not delivered toward the axial center to be approximately orthogonal to the outer wall of the inner cylinder 24. By changing the direction of the solid-gas two-phase flow using the fixed vanes 23, i.e., by changing the velocity component of the flow in the horizontal direction depending on the inclined angle θ, the solid-gas two-phase flow is swirled in the circumferential direction within a space formed between the inner wall of the cone 21 and the outer wall of the inner cylinder 24. Incidentally, in the exemplified structure shown in FIG. 1(b), the solid-gas two-phase flow forms a swirling flow in the clockwise direction.

Since the deflectors 26 strengthening the solid-gas two-phase flow delivered into the inside of the cone 21 in the downward direction are provided at inlets of the fixed vane inlet windows 22, the direction of the upward flow is changed to the downward direction from the approximately horizontal direction. In other words, the deflectors 26 extending obliquely downward and attached to the outer sides of the fixed vane inlet windows 22 forcibly changes the direction of the solid-gas two-phase flow passing through the deflectors 26 into the obliquely downward direction as shown by arrow f in FIG. 1. Accordingly, the downward velocity component of the flow delivered into the inside of the cone 21 by the deflectors 26 is increased. Thus, the velocity component of the solid-gas two-phase flow delivering from the fixed vane inlet windows 22 and heading to the axial center to be approximately orthogonal to the outer wall of the inner cylinder 24 is reduced by the fixed vanes 23 and the deflectors 26 in the horizontal direction and vertical direction.

As described above, the deflectors 26 extending obliquely downward, i.e., blind-type guide vanes, are disposed on the outer sides of the fixed vane inlet windows 22 to strengthen the solid-gas two-phase flow in the downward direction. Accordingly, the solid-gas two-phase flow passing by the fixed vanes 22 are strengthened to be directed downward. Consequently, it is highly likely that heavy coarse powder is directly delivered downward, and thus the amount of coarse powder delivered toward the axial center of the fixed classifier 20 including the inner cylinder 24 and the pulverized coal outlet 16 can be reduced.

Therefore, the amount of coarse powder swept up in the solid-gas two-phase flow and delivered upward with fine powder product by the reverse upward flow to be discharged from the fixed classifier 20 is reduced. Thus, the classification accuracy of the fixed classifier 20 is improved.

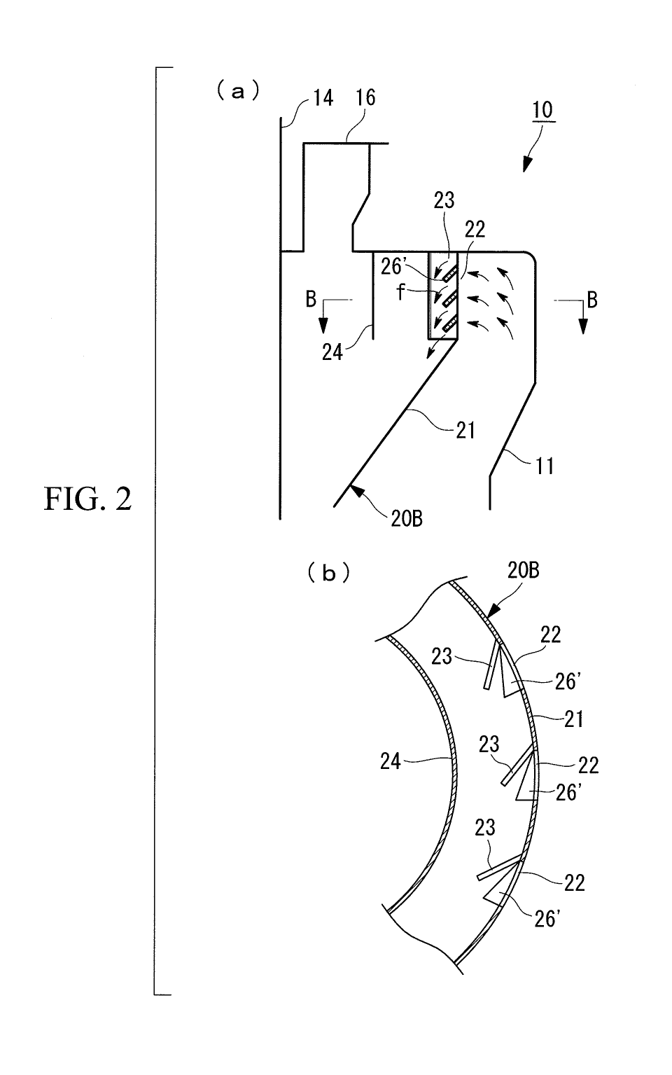

The deflector 26 according to the embodiment may be a flat plate or curved plate as long as it has a shape changing the direction of the solid-gas two-phase flow into the downward direction. Also, the three deflectors 26 are illustrated in FIG. 2, but the number of the deflectors 26 is not limited thereto. In other words, it is only required that the deflector 26 changes the direction of the solid-gas two-phase flow to the downward direction, and thus the shape or number thereof can be appropriately selected depending on the condition.

Although the deflectors 26 are arranged on the outer sides of the fixed vane inlet windows 22 in the above-described embodiment, the same advantageous effects can be obtained when deflectors 26′ are arranged on the inner sides of the fixed vane inlet windows 22 as in a fixed classifier 20B according to a first modification as shown in FIG. 2. At this time, it is required that the deflectors 26′ and the fixed vanes 23 are not interfered with each other.

As the deflecting members according to the embodiment, both of the deflectors 26 arranged on the outer sides of the fixed vane inlet windows 22 and the deflectors 26′ arranged on the inner sides of the fixed vane inlet windows 22 may be provided.

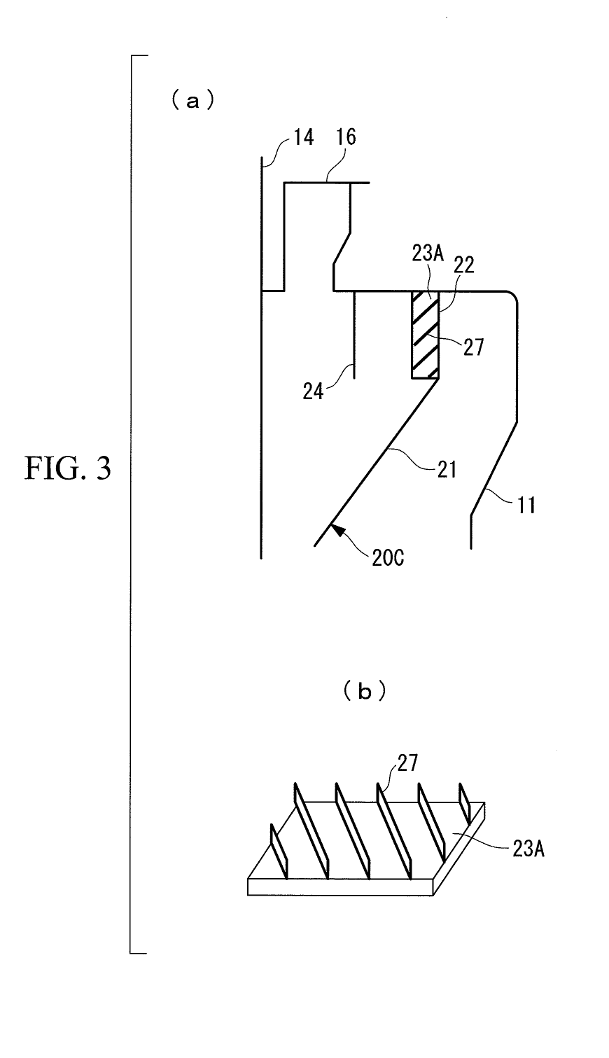

Also, as the deflecting member according to the embodiment, a fixed vane 23A with deflecting blades 27 corresponding to the deflectors 26 and 26′ may be provided as in a fixed classifier 20C according to a second modification as shown in FIG. 3. More specifically, in the second modification, the plurality of deflecting blades 27 (six blades in FIG. 3) guiding the solid-gas two-phase flow in the obliquely downward direction are provided on the surface of the fixed vane 23A which is close to the fixed vane inlet windows 22 to form obliquely downward deflecting blade rows.

Such deflecting blades 27 increase the downward velocity component of the solid-gas two-phase flow guided by the obliquely downward deflecting blades 27 to be delivered into the inside of the cone 21 as well as the deflectors 26 and 26′. Especially, coarse particles having relatively large inertial force tend to be delivered along the fixed vane 23A, and accordingly, a large deflecting effect can be brought by the deflecting blades 27. Incidentally, the shape of the deflecting blade 27 is not limited to a particular shape such as a flat plane and curved plane. The number of the deflecting blades 27 can be appropriately changed depending on the condition.

Although the deflecting blades 27 are attached to the surface of the fixed vane 23A close to the fixed vane inlet windows 22 in the above description, they may be attached to both surfaces.

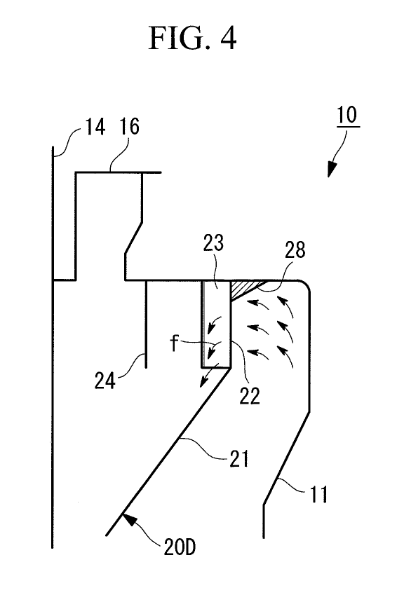

As the deflecting member according to the embodiment, an inclined surface 28 having the same function as that of the deflectors 26 and 26′ may be provided as in a fixed classifier 20D according to a third modification as shown in FIG. 4. The inclined surface 28 is formed on the upmost portion of the casing 11 to guide the flow to the fixed vane inlet windows 22. By forming the inclined surface 28 smoothly connecting the ceiling portion of the casing 11 and the fixed vane inlet windows 22, the solid-gas two-phase flow passing along the inclined surface 28 is guided by the obliquely downward surface to be delivered into the inside of the cone 21. Thus, the velocity component in the downward direction is increased as when the deflectors 26 are formed. The inclined surface 28 is not limited to a particular shape such as a flat plane and curved plane.

The deflecting members according to the embodiment and modifications may be provided separately, or may be provided in combination.

### Second Embodiment

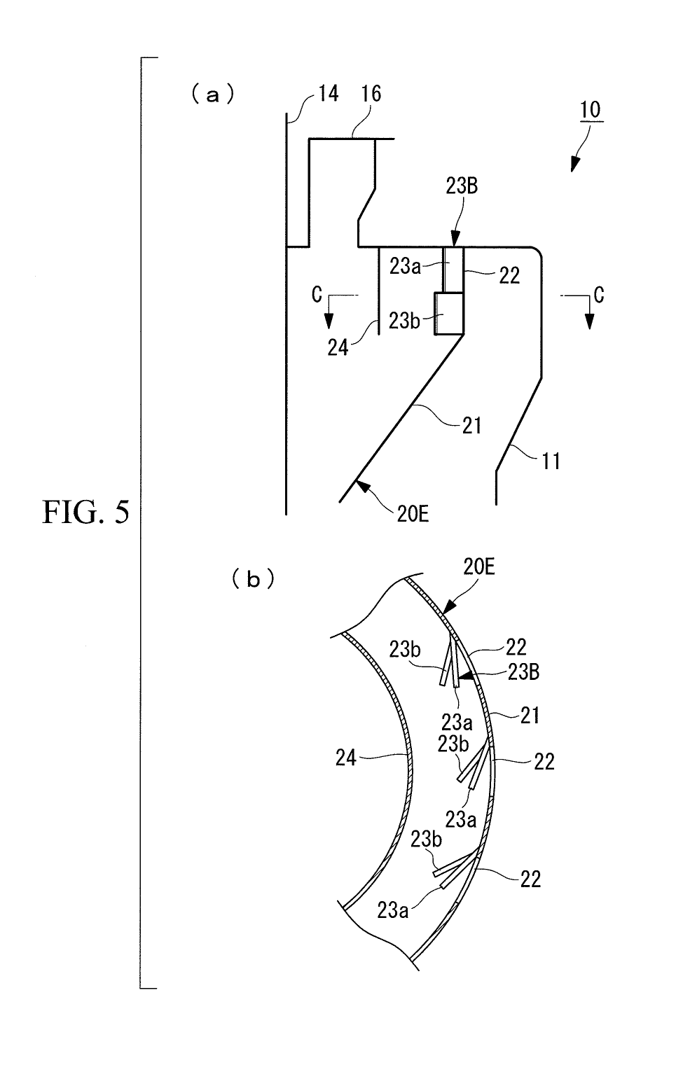

A vertical roller mill according to a second embodiment of the present invention will be explained below with reference to FIG. 5. Incidentally, parts identical to those used in the first embodiment are designated by the same reference numerals, and the detailed explanation thereof will be omitted.

In a fixed classifier 20E according to the second embodiment, each fixed vane 23B is divided into two vanes in the vertical direction. An opening degree of a lower fixed vane 23b is set to be larger than that of an upper fixed vane 23a. More specifically, an inclined angle θ of the upper fixed vane 23a is increased to throttle its opening degree, and an inclined angle θ of the lower fixed vane 23b is decreased to increase its opening degree.

By providing such a fixed vane 23B, a velocity component along the inner wall of the cone 21 is increased in a flow close to the upper fixed vane 23a of which the opening degree is throttled, and the amount of coarse powder delivered approximately horizontally to the axial center of the fixed classifier 20 and entrained in the reverse upward flow is reduced. In other words, the solid-gas two-phase flow delivered from the fixed vane inlet windows 22 changes its direction to the approximately horizontal direction from the upward flow. Accordingly, powdery particles (pulverized coal) in the solid-gas two-phase flow tend to be delivered to the upper side by inertial force according to their coarse particles having a large particle diameter (a powder concentration at the upper side is increased). Thus, when the velocity component along the inner wall of the cone 21 is increased in the flow at the upper side, the probability that the coarse particles deflected to the upper side are entrained in the reverse upward flow is reduced.

In the second embodiment, by throttling the opening degree of the upper fixed vane 23a by which the solid-gas two-phase flow having a high proportion of coarse particles passes, the coarse particles are prevented from heading to the axial center of the fixed classifier 20. Thus, the classification accuracy is improved as a whole. In other words, by throttling the opening degree of the fixed vane at the upper side where the particle concentration is high, the fixed vane 23B according to the second embodiment prevents the reduction of the classification efficiency and ensures a desired fineness by adjusting the opening degrees of the upper and lower fixed vanes.

Although the fixed vane 23B divided into two vanes in the vertical direction is adopted in the second embodiment, the divided proportion of the upper fixed vane 23a and the lower fixed vane 23b may be appropriately adjusted. Alternatively, the fixed vane 23B may be divided into three vanes or more in the vertical direction and their opening degrees may be set to be increased from the upper vane to the lower vane in a stepwise manner. Further, an inclined plate-shaped or curved mounting structure or shape of the fixed vane may be adopted so that the opening degrees are continuously changed from the upper vane to the lower vane.

Incidentally, when the fixed vane is divided into a plurality of vanes in the vertical direction and their opening degrees are set to be increased from the upper vane toward the lower vane in a stepwise manner like the fixed vane 23B, the structure in which the opening degree of the fixed vane 23B is increased downward in a stepwise manner can be easily provided.

### Third Embodiment

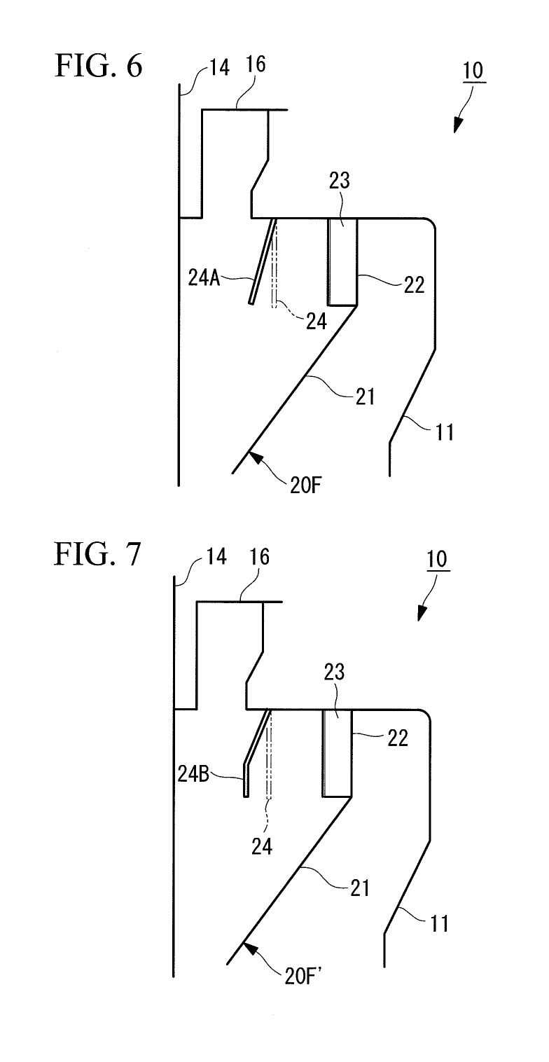

Next, a vertical roller mill according to a third embodiment of the present invention will be explained below with reference to FIG. 6. Incidentally, parts identical to those used in the above-described embodiments are designated by the same reference numerals, and the detailed explanation thereof will be omitted.

In a fixed classifier 20F according to the third embodiment, a lower end portion of an inner cylinder 24A has a shape for expanding a space formed between the lower end portion and the fixed vanes 23. More specifically, the inner cylinder 24A shown in FIG. 6 has a conical trapezoidal shape narrowing toward the lower end portion. Accordingly, the distance for coarse powder delivered toward the axial center of the fixed classifier 20 from the fixed vanes 23 to reach the inner cylinder 24A is increased. Consequently, the probability that heavy coarse particles are entrained in the reverse upward flow heading to the inner upper side of the inner cylinder 24A from the inlet of the inner cylinder 24A is reduced. Thus, the classification accuracy is effectively improved.

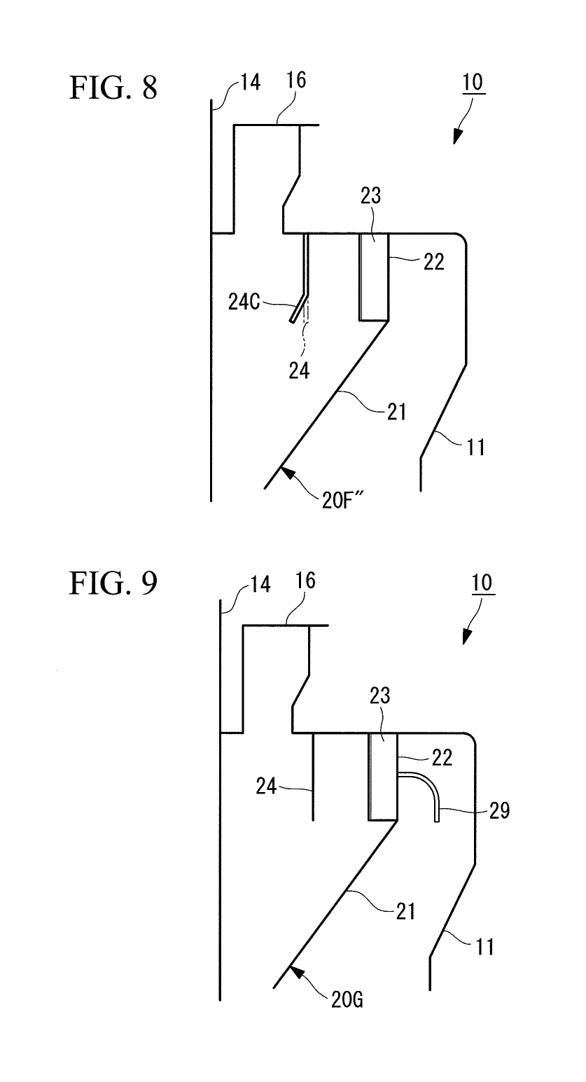

The shape of the inner cylinder 24A expanding the space formed between its lower end portion and the fixed vanes 23 is not limited to the conical trapezoidal shape narrowing toward the lower end portion. For example, the shape provided by combining the conical trapezoidal shape narrowing toward the lower end portion and the cylindrical shape is possible like a fixed classifier 20F′ according to a first modification of the third embodiment as shown in FIG. 7 and a fixed classifier 20F″ according to a second modification as shown in FIG. 8.

When the conical trapezoidal shape and the cylindrical shape are combined, an inner cylinder 24B may be provided by connecting a cylinder to a lower end portion of a cone so that its diameter is reduced toward the lower end portion as in the fixed classifier 20F′ according to the first modification as shown in FIG. 7. Alternatively, an inner cylinder 24C may be provided by connecting the cone to the lower end portion of the cylinder so that its diameter is reduced toward the lower end portion as in the fixed classifier 20F″ according to the second modification as shown in FIG. 8.

### Fourth Embodiment

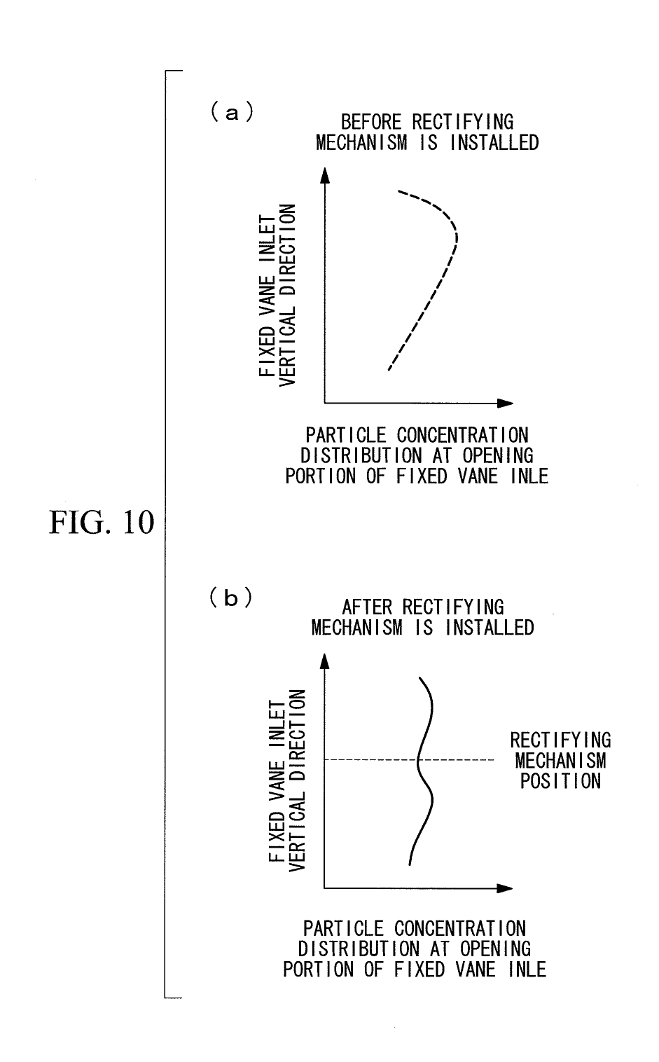

Next, a vertical roller mill according to a fourth embodiment of the present invention will be explained below with reference to FIGS. 9 and 10. Incidentally, parts identical to those used in the above-described embodiments are designated by the same reference numerals, and the detailed explanation thereof will be omitted.

In a fixed classifier 20G according to the fourth embodiment, one substantially quadrant rectifying mechanism 29 dividing the solid-gas two-phase flow in the vertical direction is provided at the inlet of the fixed vane inlet window 22. Since the solid-gas two-phase flow delivered from the fixed vane inlet windows 22 changes its direction to the approximately horizontal direction from the upward flow, pulverized coal (powder) in the solid-gas two-phase flow tend to describe a particle concentration distribution as shown in FIG. 10(a) according to which coarse particles having a large particle diameter are deflected to the upper side (the ceiling of the casing 11) by inertial force.

Thus, in the region at the upper end side where the particle concentration is high, particles in the solid-gas two-phase flow are crashed, interfered, and grouped, which causes the reduction of the classification accuracy.

However, by providing the above-described rectifying mechanism 29, the solid-gas two-phase flow is divided into two flows in the vertical direction when its direction is changed. Accordingly, the influence of the inertial force can be minimized. Consequently, the deviation of the particle concentration distribution formed by the solid-gas two-phase flow in the vertical direction is corrected as shown in FIG. 10(b), so that the solid-gas two-phase flow is delivered to the fixed vanes with the substantially constant particle concentration distribution. When the particle concentration distribution caused by the deflected flow is corrected, the particles are not easily crashed, interrupted, and grouped in the solid-gas two-phase flow delivered to the fixed vanes with the substantially constant particle concentration distribution. Thus, the classification accuracy is efficiently improved.

The shape of the rectifying mechanism 29 is not limited to a curved plane such as a substantially quadrant shape as shown in FIG. 9. For example, the shape of the rectifying mechanism 29 may be provided by combining a plurality of straight lines.

Also, the number of the rectifying mechanism 29 is not limited to one as shown in FIG. 9. A plurality of rectifying mechanisms 29 may be appropriately provided depending on the condition, which is appropriately changeable.

According to the above-described embodiments and their modifications, the vertical roller mill 10 with the fixed classifier 20A to 20F can reduce a proportion of coarse particles in a pulverized coal product (for example, a proportion of coarse particles larger than 100 mesh). Accordingly, by applying it to a pulverized coal-fired boiler, a proportion of coarse particles in a pulverized coal product can be reduced and thus an unburned content in the coal can be reduced. The fixed classifiers 20A to 20F, which can be easily maintained at low cost because of a simple structure without a drive part, can be adopted as a classifier for relatively combustible low-grade coal to provide a pulverized coal-fired boiler which burns low-cost and low-grade coal as pulverized coal fuel.

The above-described embodiments and their modifications can be applied separately, but also can be applied in combination depending on the condition. For example, the classification accuracy is further increased by combining the deflectors 26 and the inner cylinder 24A.

The present invention is not limited to the above-described embodiments, and can be modified without departing from the spirit and scope of the present invention.

### REFERENCE SIGNS LIST

10 vertical roller mill
11 casing
12 grinding table
13 grinding roller
14 coal injection tube
15 throat
16 pulverized carbon outlet (fine powder outlet)
20, 20A to 20G fixed classifier
21 cone (conical member)
22 fixed vane inlet window
23, 23A, 23B fixed vane
24, 24A to 24C inner cylinder
25 fine powder outlet
26, 26′ deflector
27 deflecting blade
28 inclined surface
29 rectifying mechanism

1. A vertical roller mill, comprising:
a cyclone-type fixed classifier provided within a casing for classifying fine powder having a small particle diameter by centrifugal force in a solid-gas two-phase flow conveying powder provided by crushing a solid and for discharging the fine powder to an outside, the fixed classifier being adapted to discharge the fine powder to the outside from a fine powder outlet at an upper side through a lower end portion of an inner cylinder provided inside a conical member by introducing the solid-gas two-phase flow into an inside of the conical member from a fixed vane inlet window opened on the conical member and swirling the solid-gas two-phase flow using a fixed vane mounted near an inner side of the fixed vane inlet window; and
a deflecting member provided near the fixed vane inlet window for strengthening the solid-gas two-phase flow delivered into the inside of the conical member from the fixed vane inlet window in a downward direction.

2. The vertical roller mill according to claim 1, wherein the deflecting member is a deflector extending obliquely downward and attached on at least one of an outer side and the inner side of the fixed vane inlet window.

3. The vertical roller mill according to claim 1, wherein the deflecting member is one or a plurality of deflecting blades extending obliquely downward and attached to the fixed vane.

4. The vertical roller mill according to claim 1, wherein the deflecting member is an inclined surface formed on an uppermost portion of the casing and guiding the flow to the fixed vane inlet window.

5. A vertical roller mill, comprising:
a cyclone-type fixed classifier provided within a casing for classifying fine powder having a small particle diameter by centrifugal force in a solid-gas two-phase flow conveying powder provided by crushing a solid and for discharging the fine powder to an outside, the fixed classifier being adapted to discharge the fine powder to the outside from a fine powder outlet at an upper side through a lower end portion of an inner cylinder provided inside a conical member by introducing the solid-gas two-phase flow into an inside of the conical member from a fixed vane inlet window opened on the conical member and swirling the solid-gas two-phase flow using a fixed vane mounted near an inner side of the fixed vane inlet window, wherein
an opening degree of the fixed vane is increased continuously or gradually in a downward direction.

6. The vertical roller mill according to claim 5, wherein the fixed vane is divided into a plurality of vanes in a vertical direction and opening degrees thereof are gradually increased from an upper vane to a lower vane.

7. A vertical roller mill, comprising:
a cyclone-type fixed classifier provided within a casing for classifying fine powder having a small particle diameter by centrifugal force in a solid-gas two-phase flow conveying powder provided by crushing a solid and for discharging the fine powder to an outside, the fixed classifier being adapted to discharge the fine powder to the outside from a fine powder outlet at an upper side through a lower end portion of an inner cylinder provided inside a conical member by introducing the solid-gas two-phase flow into an inside of the conical member from a fixed vane inlet window opened on the conical member and swirling the solid-gas two-phase flow using a fixed vane mounted near an inner side of the fixed vane inlet window, wherein
the lower end portion of the inner cylinder has a shape which expands a space formed between the lower end portion and the fixed vane.

8. A vertical roller mill, comprising:
a cyclone-type fixed classifier provided within a casing for classifying fine powder having a small particle diameter by centrifugal force in a solid-gas two-phase flow conveying powder provided by crushing a solid and for discharging the fine powder to an outside, the fixed classifier being adapted to discharge the fine powder to the outside from a fine powder outlet at an upper side through a lower end portion of an inner cylinder provided inside a conical member by introducing the solid-gas two-phase flow into an inside of the conical member from a fixed vane inlet window opened on the conical member and swirling the solid-gas two-phase flow using a fixed vane mounted near an inner side of the fixed vane inlet window; and
a rectifying mechanism provided at an inlet of the fixed vane inlet window for dividing the solid-gas two-phase flow in a vertical direction.
